(19) United States
(12) Patent Application Publication
(10) Pub. No.: US 2013/0123996 A1
(43) Pub. Date: May 16, 2013

(54) METHOD AND SYSTEM FOR IMPROVING THE EFFECTIVENESS OF PLANNED POWER CONSUMPTION DEMAND RESPONSE EVENTS

(71) Applicant: Gilberto Augusto Matos, Plainsboro, NJ (US)

(72) Inventor: Gilberto Augusto Matos, Plainsboro, NJ (US)

(21) Appl. No.: 13/675,160

(22) Filed: Nov. 13, 2012

Related U.S. Application Data
(60) Provisional application No. 61/559,208, filed on Nov. 14, 2011.

(51) Int. Cl. G06F 1/26

(52) U.S. Cl. CPC G06F 1/26
USPC 700/291

(57) ABSTRACT

A method and system for defining and optimizing demand response events is disclosed where at least one initial input parameter is received for selection of a demand response event, a power demand forecast is retrieved, a demand response event is automatically calculated based on the at least one initial input parameter and the power demand forecast, and an interactive user interface, the interactive user interface is generated and includes the power demand forecast, an expected power capacity forecast, and the demand response event.

This application claims the benefit of U.S. Provisional Application No. 61/559,208, filed Nov. 14, 2011, the disclosure of which is herein incorporated by reference.

### BACKGROUND

The present invention directed to method and system for improving the effectiveness of planned power consumption demand response events, more particularly defining and optimizing power consumption demand response events, according to an embodiment.

Forecasts of power consumption for any given set of electrically powered devices are commonly used to plan for generation of power capacity being kept “on standby” to satisfy power consumption demand. These forecasts can also be used in the planning and optimization of demand response events, where certain consumers are asked to drop or shift their power consumption during high demand periods. Several studies show that planning and optimization of demand response events have the potential to significantly optimize performance of power networks and utilities. Current power networks and utilities systems base the demand response (DR) events on specifying event parameters such as duration and required load reduction, and then verify the resulting behavior based on real time meter data. The resulting behavior can also be verified during settlement after the demand response event has occurred. This generally means that utilities and DR aggregators need to invoke events which are larger than is actually necessary, so that they have a buffer of load reduction that improves their probability of satisfying the contracted capacity, which leads to incurrence of larger costs in satisfying DR events.

Current power networks and utilities have a disadvantage of manual entry of event parameters without feedback, which contains forecast response, as the current power networks and utilities rely entirely on a user calculating the right parameters. Such systems are error prone if there is a lot of input data, and reducing the amount of data by pre-calculation raises the issue of losing track of important outliers or consumption patterns that could be used in planning optimized events.

### BRIEF SUMMARY

The present invention provides a method and system for improving the effectiveness of planned demand response events. Embodiments of the present invention include approach in defining and maintaining energy policy that ensures efficient energy consumption.

In one embodiment, a method for defining and optimizing power consumption demand response events includes receiving at least one initial input parameter for selection of a demand response event, retrieving a power demand forecast, automatically calculating a demand response event, generating an interactive user interface which comprises the power demand forecast, an expected power capacity forecast, and the demand response event, and outputting the power demand forecast to the interactive user interface.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary method for planning and optimization of demand response events for power consumption, according to an embodiment of the present invention;

FIG. 2 illustrates an exemplary Initial Input interface, according to an embodiment of the present invention;

FIG. 3 illustrates an exemplary interactive user interface, according to an embodiment of the present invention;

FIG. 4 illustrates an exemplary Direct Entry and Selection user interface, according to an embodiment of the present invention;

FIG. 5 illustrates exemplary display of uncertainty of DR event response, according to an embodiment of the present invention;

FIG. 6 illustrates an exemplary interactive user interface displaying event parameters adjusted in a constant power consumption reduction mode, according to an embodiment of the present invention; and

FIG. 7 is a high-level block diagram of a computer that may be used to implement the present invention.

### DETAILED DESCRIPTION

The present disclosure is directed to system and method for improving the effectiveness of planned demand response events. Embodiments of the present invention provide for a method and system that allows power networks and utilities companies to define and optimize demand response (DR) events for uncertain forecasts for power consumption.

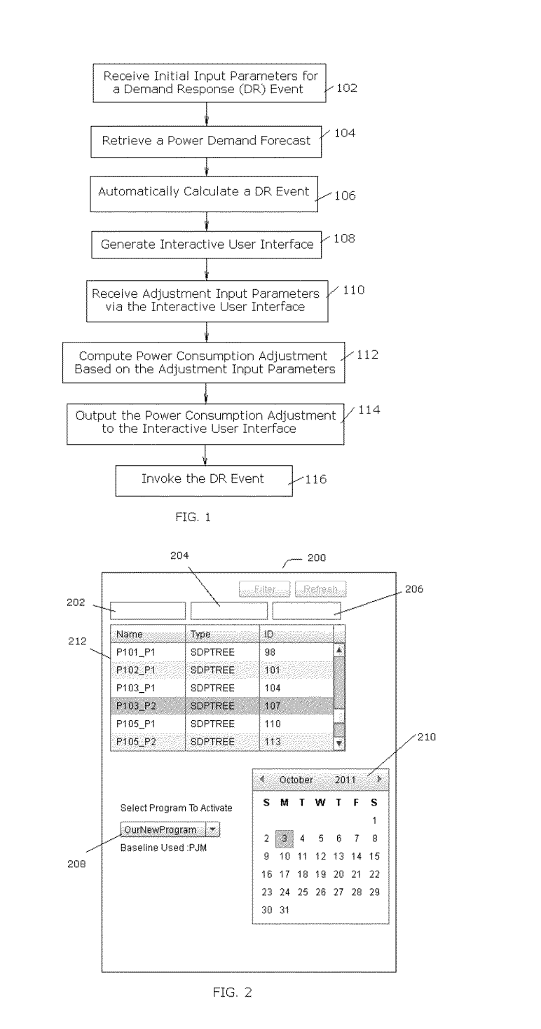

FIG. 1 illustrates an exemplary method 100 for planning and optimization of demand response events for power consumption, according to an embodiment of the present invention.

At step 102, power consumption parameters are received as input parameters from a user. In an advantageous embodiment, the power consumption parameters are defined by the user and may include coarse grained parameters of a planned DR event, such as date of interest, geographical area of interest, and a type of DR program that should be used for necessary power load reduction. Table 1 illustrates an exemplary (e.g., cooling) program which includes a set of events characterized geographical area of interest, date/time, duration, and required and/or optimal modification in power consumption:

TABLE 1
COOLING

| Event Target | Start Time | Duration | Reduction |
|---|---|---|---|
| Region Central | Jul. 18th, 11 am | 3 hours | 10 MW |
| TransLine 1 | Jul. 18th, 10:30 am | 1 hour | 2 MW |
| IndustryZone 2 | Jul. 18th, 1:30 pm | 1 hour | 1 MW |

It is to be understood that the power consumption may include a consumption of natural and/or man-made resources. In an embodiment, input parameters can be received via an Initial Input interface of FIG. 2.

FIG. 2 illustrates an exemplary Initial Input interface 200, according to an embodiment of the present invention. The Initial Input interface 200 can be utilized to receive a plurality of input parameters from the user at step 102. In an embodiment, the Initial Input interface 200 can include a plurality of modifiable search fields, to be used for filtering from a large number and variety of DR event targets, so that a single target can then be selected for the actual event. In particular, a name search field 202 allows a user to filter the DR event target by name, a type search field allows a user to filter the DR event target by type, and an ID search field 206 allows a user to filter the DR event target by ID. The resulting DR event targets are displayed in the table 212. Each row of the table 212 represents a DR event target that is an aggregation of loads that can be selected for a DR event. A program field 208 is provided for selection of a DR program to be used for necessary and/or optimal power load reduction, and a calendar field 210 is provided for selection of a date for which a DR program should be selected for necessary power load reduction.

It is to be understood that the Initial Input interface 200 can be presented in form of a dialog-box on a screen of computing devices of various types (desktops, laptops, hand-held devices, PDAs, and the like), where such computing devices are controlled by a server-based and/or web-based control servers of power and utilities companies. For example, the interactive user interface can be a web-based graphical interface accessed by the user device. In this case, the user device which displays the interactive user interface can be a separate computing device from the computing device which can be configured to perform the steps of FIG. 1. It is also to be understood that the Initial Input interface 200 can be activated and/or controlled by input means, such as touch screen, keyboard, mouse, button, voice command, etc. In an embodiment of the present invention, the user can submit complex hybrid power consumption requirements that schedule a variety of requests directed at certain range of temperature, humidity, and lighting depending on certain period of time.

Those skilled in the art will understand that the Initial Input interface 200, as described above, is non-limiting and that its components may be combined in any way in various embodiments and may include any additional and/or desired components and/or configurations.

Returning to FIG. 1, at step 104, a power demand forecast corresponding to received input parameters is retrieved, according to an embodiment of the present invention. It is to be understood that the power demand forecast retrieved at step 104 can be generated periodically (e.g., hourly, daily, weekly, monthly, quarterly, etc.) and in advance of user and/or system requests based on real-time data or based on system historical reaction to prior generated power consumption demands. The power demand forecast data can be stored upon generation in one or more databases accessible by the control servers of the power and utilities companies. In an embodiment, the power demand forecast can include the power demand forecast for the geographical area and the date when the power consumption is expected to reach high and/or critical levels based on the external environmental parameters (temperature, humidity), planned outages in the power generation capacity, and external economic parameters, such as a price of energy on the future and spot market, and forecasts for such prices based on the consumption and generation forecasts. Expected power capacity can also be retrieved.

At step 106, a demand response (DR) event is automatically calculated based at least on the input parameters received from the user at step 102 and based on the power demand forecast retrieved at step 104. In particular, a necessary reduction of power consumption can be calculated based on a portion of the power demand forecast that exceeds the expected power capacity, and a DR event that complies with the input parameters can be calculated to achieve the necessary reduction of power consumption. It is to be understood that the compliance of the DR event with the initial parameters can include start/stop time of the DR event, duration of the necessary reduction of power consumption and the like.

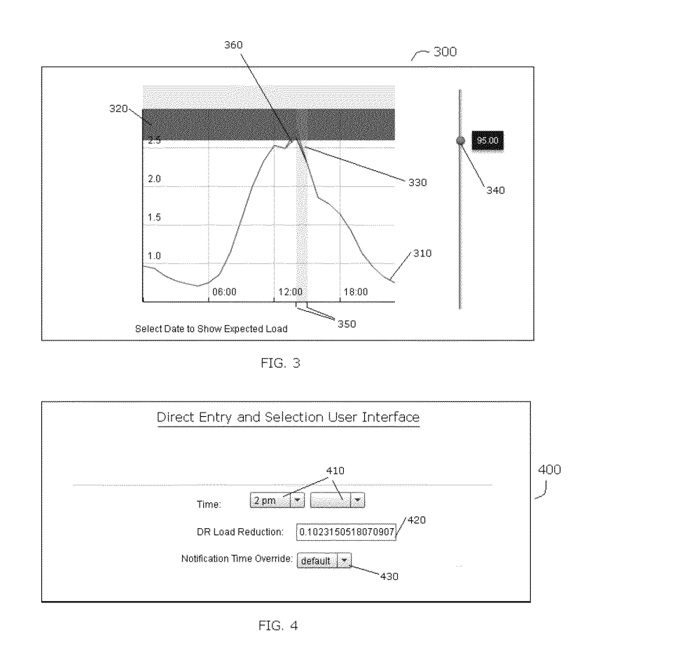

At step 108, an interactive user interface is generated. FIG. 3 illustrates an exemplary interactive user interface 300 which can be generated at step 106 of FIG. 1, according to an embodiment. In accordance with an advantageous embodiment, the interactive user interface 300 can be presented in the form of a graph that illustrates the forecast demand for power consumption 310 measured in Megawatt (MW) or in Kilowatt (KW). It is to be understood that a selection of measurement units is a variable which can depend on a target utility and the size of the target utility while a processor and the Interactive User Interface are in sync. It is also possible that measurement units can be determined dynamically based on displayed data during a time limits provided by the user as one of the input parameters. One skilled in the art will recognize that power consumption may be quantified in BTU or in KwH/MwH as an actual electrical power consumption during a small time interval for natural gas/propane, tons for coal, etc.

In an embodiment, the interactive user interface 300 can also display the expected power capacity 320 at or around the time provided by the user as one of the input parameters. A combined illustration of forecast demand for power consumption 310 and the expected power capacity 320 can serve to provide the user with a visual indication of the expected power or transmission shortages (i.e., critical values) at or around the time provided by the user.

In an advantageous embodiment of the present invention the interactive user interface 300 can also include the DR event 360 automatically calculated at step 106 when the forecast demand for power consumption exceeds the expected power capacity. It is to be understood that the DR event 360 may be presented in the form of a graph reflecting a change in power consumption during the period of time and the geographical area specified by the user at step 102 in the form of the initial input parameters. In an embodiment of the present invention, the DR event 360 can be: a separate graph identified by a different color, a separate line of same or different line width, or a dotted graph. In another embodiment, the DR event 360 can be presented in the form (in whole or in part) of modified graph illustrating the forecast demand of power consumption 310. Those skilled in the art will understand that the interactive user interface 300, as described above, is non-limiting and that its components may be combined in any way in various embodiments and may include any additional and/or desired components and/or configurations.

In one embodiment, displayed parameters can be modified by repositioning the forecast demand for power consumption 310, the expected power capacity 320, and/or the time interval 330 on the screen of the interactive user interface 300. For example, the user can adjust a vertical slider 340 to modify expected critical value in the forecast demand for power consumption 310, and in response to this adjustment the calculation for required load reduction is automatically updated and a new expected outcome is displayed in the predicted load chart. Similarly, the user can adjust the time interval 330 by repositioning the horizontal sliders 350 and in response to this adjustment the expected response is automatically calculated based on the DR event parameters.

In one other embodiment, displayed time and event parameters can be modified by entering adjustment parameters in a Direct Entry and Selection user interface. FIG. 4 illustrates an exemplary Direct Entry and Selection user interface 400, according to an embodiment. In an embodiment, the exemplary Direct Entry and Selection user interface 400 can include a plurality of input fields, such as date/time input field 410, proposed DR load reduction field 420, requested notification field 430. It is to be understood that the use of the Direct Entry and Selection user interface 400 is equivalent of a use of graphical tools within the interactive user interface 300 of FIG. 3. Those skilled in the art will understand that the Direct Entry and Selection user interface 400, as described above, is non-limiting and that its components may be combined in any way in various embodiments and may include any additional and/or desired components and/or configurations.

Returning to FIG. 1, at step 110 an adjustment input parameters are received via the interactive user interface, according to an embodiment of the present invention. Returning again to FIG. 3, in an advantageous embodiment, interactive user interface 300 can include graphical tools for the user to use in order to modify a plurality of parameters visually presented by the interactive user interface 300, such as duration of the DR event 360. Modifications of displayed parameters can cause the automatic calculation and display of the expected power load reduction.

Returning to FIG. 1, at step 112, based on received adjustment input parameters, power consumption adjustment is automatically calculated. In an embodiment, the power consumption adjustment can be calculated based on dependence of the power consumption on a plurality of natural or man-created factors. It is to be understood that the system for defining and optimizing DR events can support a wide variety of DR events by basing its presentation on a pre-determined reduction in consumption of a scarce and valuable resource over a specific period of time with high expected use. In an embodiment, the system can support emergency DR events by providing capabilities for keeping the demand below critical levels. In another embodiment, the system can support economic programs by planning DR events based on percentage reduction in demand or by evaluating the actual cost of energy as the controlled parameter in the interactive user interface. In yet another embodiment, the system can also support energy consumption programs concentrated at reducing the consumption by a target amount, where the duration and complexity of the program can become dependent variables, so that an increase in the event duration proportionally decreases the event magnitude, and vice versa.

At step 114, automatically calculated power consumption adjustment is outputted to the interactive user interface. Since simple calculation can be utilized to estimate the power consumption adjustment in a complex system, the results are assumed to have a significant error potential. To mitigate the error potential, the system provides to the user a graphical representation of a scalar value indicating the reasonably expected participation ratio for a given DR event. In an exemplary embodiment, the participation ratio can be set at 85% to be consistent with an assumption that a15% buffer in the magnitude of the initially planned DR event will allow the system to create DR events with high confidence that requested load reductions will actually be achieved. However, the present invention is not limited to any specific value for the participation ratio. In another embodiment, the user can be provided with an option to modify a participation ratio to adjust the expected load reduction for a planned DR event. In yet another embodiment, the display of the expected system behavior can also include an indication of a potential variation. For example, as opposed to just one participation ratio measure, a best case/worst case measure can be used to mitigate the error potential. The best case/worst case measure can identify the maximum and minimum load reduction that can be expected for a selected DR event. Using the assumption of expected 85% participation, it can be determined that the worst case participation could be 80% and best case could be 90%. It is to be understood that the best case can be significantly above 100%, and worst case can even be a negative value if the user raises her consumption instead of reducing it. It is also to be understood that pragmatic outcomes are expected as the user can be incentivized to collaborate.

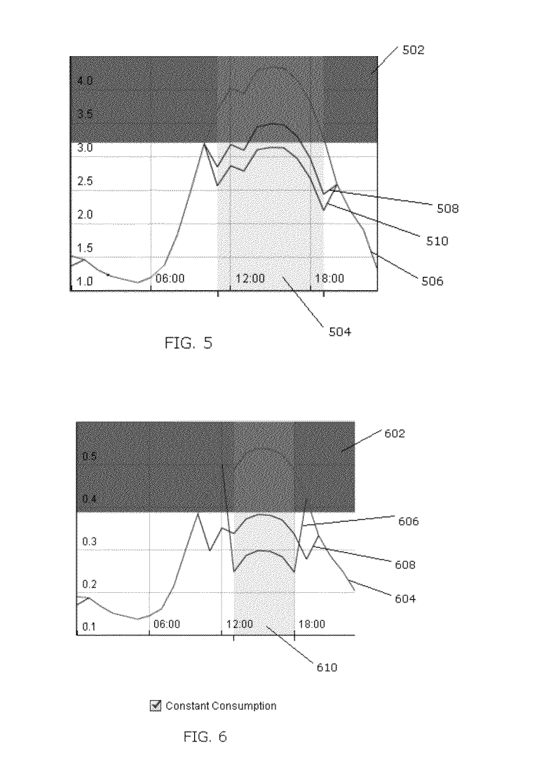

In an embodiment, the variability range can also be manipulated to reflect the more stringent participation rules of some programs. Similarly to the uncertainty, along with the developed participation prediction algorithms, the variation/range of best to worst case indicator can be utilized to present to the user, in an intuitive and graphical manner, how closely the DR event buffer can be calculated in the planning for any given situation. It is to be understood that a simple constant or multiplicative range can be used to model the variability until a better estimation mechanism is available. FIG. 5 illustrates exemplary display of uncertainty of DR event response, according to an embodiment. Particularly, FIG. 5 illustrates exemplary interactive user interface displaying expected system behavior where line 506 represents the expected load without the DR event, line 508 indicates the worst case of the expected participation, and line 510 represents the best case of the expected participation, for an identified time interval 504 and the expected power capacity 502. Accordingly, as shown in FIG. 5, a single line that is an indication of expected participation is replaced by the two lines 508 and 510 that illustrate the reasonably expected range of participation When the system's feedback to event parameters is calculated and displayed as a range of possible outcomes (e.g., worst and best), the user is enabled to manage the risks both in terms of power network stability (e.g., looking for satisfying the constraints in the worst case) and in terms of energy trading costs (where an average case or best case compliance may better reflect the optimal system control procedure). It is to be understood that, the range of possible outcomes may also be calculated and displayed. According to an advantageous embodiment, the feedback may also be presented in the form of one or more textual, visual, or audio suggestions to the user on how to further optimize power consumption.

In addition to determining the scale of DR events based on peak demand reduction, the system can also work based on a target reduction of power consumption. The key difference is that the total consumption reduction can be fixed at any point in the event scheduling process and subsequent refinements of the event parameters then are treated as modifications to dependent variables. Since the total consumption reduction is equal to event duration multiplied by the load reduction, a constant consumption setting implies that when one event parameter grows by a specific multiple, the other needs to be reduced by dividing it by the same value. For example, if the original event parameters are 10 MW and 10 hours, and the user wants to start the event one hour earlier, then the resulting parameters for constant consumption reduction settings will be 11 hours and 9.0909 MW of desired load reduction. The system can be configured to show the original event parameters and the modified event, or just to show the range of the resulting events as with the other event parameter changes.

FIG. 6 illustrates an exemplary interactive user interface displaying event parameters adjusted in a constant power consumption reduction mode, according to an embodiment. Particularly, the interactive user interface displays the expected power capacity 602 and the forecast demand for power consumption 604. In an embodiment, the constant power consumption reduction mode is enabled to place an additional constraint on modifications to any of a plurality of event parameters. The two events 606 and 608 can be presented as alternatives where the user is able to select the one that better fits the user's expected power and load reduction needs. The DR event 606 is a variation where the user can modify the event within constant consumption so as to provide a load reduction buffer for the peak load times, and allow some overload to occur before and after the peak. It is to be understood that any remaining high loads at non-peak times may be addressed by scheduling additional (e.g., smaller scale) DR events. As it is determined that the DR event 606 will be effectuated when the power consumption is within critical range of the expected power capacity 602, a subsequent automatic calculation is performed to refine the DR event. In an embodiment, the DR event 608 can be calculated automatically to target the maximum overload levels and the rough duration of overload situation. It is to be understood that the interactive user interface enables the user to manipulate the DR events within a constant consumption reduction constraint by adjusting the event parameters with visual feedback on the resulting expected grid loads in order to achieve any load optimization goal.

Returning to FIG. 1, at step 116, a planned DR event is invoked, as presented to the user. In an embodiment, the planned DR event start and stop time, as well as requested load reduction can become the input parameters that determine the duration and required load reduction of possible subsequently scheduled DR event. It is to be understood that the planned DR event can be invoked by the user via the interactive user interface or automatically (e.g., upon expiration of a predetermined period of time). It is also to be understood that, by being capable of initiating automatically calculated, quasi-optimal event, the system and method described herein can ensure highly optimized planning of demand response events and allow the user to finely optimize the event and take into accounts external events and characteristics. The above-described for defining and optimizing demand response events can be implemented on a computer using well-known computer processors, memory units, storage devices, computer software, and other components.

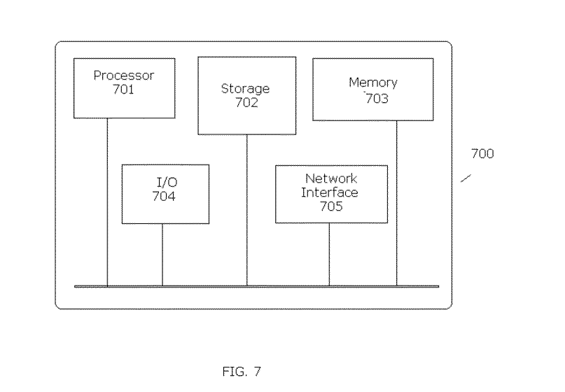

A high level block diagram of such a computer is illustrated in FIG. 7. Computer 700 contains a processor 701 which controls the overall operation of the computer 700 by executing computer program instructions which define such operation. The computer program instructions may be stored in a storage device 702 (e.g., magnetic disk) and loaded into memory 703 when execution of the computer program instructions is desired. Thus, applications for performing the method steps of FIG. 1 and interactive user interface shown in FIGS. 2-6 can be defined by the computer program instructions stored in the memory 703 and/or storage 702 and controlled by the processor 704 executing the computer program instructions. The computer 700 also includes one or more network interfaces 704 for communicating with other devices via a network. The computer 700 also includes other input/output devices 705 that enable user interaction with the computer 700 (e.g., display, keyboard, mouse, speakers, buttons, etc.).

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for defining and optimizing demand response events comprising:
receiving, by a processor, at least one initial input parameter for selection of a demand response event;
retrieving, by the processor, a power demand forecast;
automatically calculating, by the processor, a demand response event based on the at least one initial input parameter and the power demand forecast; and
generating, by the processor, an interactive user interface, the interactive user interface including the power demand forecast, an expected power capacity forecast, and the demand response event.

2. The method of claim 1, wherein, the at least one initial input parameter includes a date of interest, a time of interest, a geographical area of interest, and at least one type of a demand response event.

3. The method of claim 1, wherein the interactive user interface further includes:
at least one adjustment control unit for adjustment of the power demand forecast,
at least one adjustment control unit for adjustment of a duration of time of the demand response event.

4. The method of claim 1, wherein the power demand forecast and the expected power capacity forecast are presented in the interactive user interface in a graph-based form.

5. The method of claim 1, wherein retrieving the power demand forecast comprises retrieving the power demand forecast and the expected power capacity forecast.

6. The method of claim 1, wherein the automatically calculating the demand response event comprises:
calculating the demand response event to reduce a portion of the power demand forecast to be less than the expected power capacity forecast.

7. The method of claim 1, further comprising:
receiving, via the interactive user interface, an adjustment input parameter.

8. The method of claim 7, further comprising:
automatically calculating an adjusted power consumption based on the received adjustment input parameter; and
re-calculating the demand response event based on the adjusted power consumption.

9. The method of claim 7, wherein receiving, via the interactive user interface, an adjustment input parameter comprises:
receiving adjustment of duration of the demand response event.

10. The method of claim 7, wherein receiving, via the interactive user interface, an adjustment input parameter comprises:
receiving adjustment of the power demand forecast.

11. The method of claim 7, wherein receiving, via the interactive user interface, an adjustment input parameter comprises:
receiving adjustment of the expected power capacity.

12. The method of claim 7, further comprising:
invoking the demand response event in response to a user selection received via the interactive user interface.

13. An apparatus for defining and optimizing demand response events comprising:
means for receiving at least one initial input parameter for selection of a demand response event;
means for retrieving a power demand forecast;
means for automatically calculating a demand response event based on the at least one initial input parameter and the power demand forecast; and
means for generating an interactive user interface, the interactive user interface including the power demand forecast, an expected power capacity forecast, and the demand response event.

14. The apparatus of claim 13, wherein the means for retrieving the power demand forecast comprises:
means for retrieving the power demand forecast and the expected power capacity forecast.

15. The apparatus of claim 13, wherein the means for automatically calculating the demand response event comprises:
means for calculating the demand response event to reduce a portion of the power demand forecast to be less than the expected power capacity forecast.

16. The apparatus of claim 13, further comprising:
means for receiving an adjustment input parameter.

17. The apparatus of claim 13, further comprising:
means for automatically calculating an adjusted power consumption based on the received adjustment input parameter; and
means for re-calculating the demand response event based on the adjusted power consumption.

18. A non-transitory computer readable medium storing computer program instructions for defining and optimizing demand response events, the computer program instructions, when executed, cause a processor to perform a method comprising:
receiving, by a processor, at least one initial input parameter for selection of a demand response event;
retrieving, by the processor, a power demand forecast;
automatically calculating, by the processor, a demand response event based on the at least one initial input parameter and the power demand forecast; and
generating, by the processor, an interactive user interface, the interactive user interface including the power demand forecast, an expected power capacity forecast, and the demand response event.

19. The non-transitory computer readable medium of claim 18, wherein the interactive user interface further includes:
at least one adjustment control unit for adjustment of the power demand forecast,
at least one adjustment control unit for adjustment of a duration of time of the demand response event.

20. The non-transitory computer readable medium of claim 18, wherein retrieving the power demand forecast comprises retrieving the power demand forecast and the expected power capacity forecast.

21. The non-transitory computer readable medium of claim 18, wherein the automatically calculating the demand response event comprises:
calculating the demand response event to reduce a portion of the power demand forecast to be less than the expected power capacity forecast.

22. The non-transitory computer readable medium of claim 16, wherein the method further comprises:
receiving an adjustment input parameter;
automatically calculating an adjusted power consumption based on the received adjustment input parameter; and
re-calculating the demand response event based on the adjusted power consumption.

23. The non-transitory computer readable medium of claim 16, wherein receiving, via the interactive user interface, an adjustment input parameter comprises:
receiving adjustment of duration of the demand response event.

24. The non-transitory computer readable medium of claim 16, wherein receiving, via the interactive user interface, an adjustment input parameter comprises:
receiving adjustment of the power demand forecast.

25. The non-transitory computer readable medium of claim 16, wherein receiving, via the interactive user interface, an adjustment input parameter comprises:
receiving adjustment of the expected power capacity.

26. The non-transitory computer readable medium of claim 16, wherein the method further comprises:
invoking the demand response event in response to a user selection received via the interactive user interface.
